(19) United States
(12) Patent Application Publication
(10) Pub. No.: US 2026/0218566 A1
(43) Pub. Date: Jul. 30, 2026

(54) ROLLER SHUTTER DRIVE WITH TRAVELLING WAVE

(71) Applicant: Helmut Koester, Frankfurt (DE)

(72) Inventor: Helmut Koester, Frankfurt (DE)

(21) Appl. No.: 19/145,189

(22) PCT Filed: Dec. 23, 2023
(86) PCT No.: PCT/EP2023/087784

§ 371 Date: Jul. 1, 2025

(30) Foreign Application Priority Data
Jan. 3, 2023 (DE) 10 2023 200 053.9

(51) Int. Cl. E06B 9/322; E06B 9/68

(52) U.S. Cl. CPC E06B 9/322; E06B 2009/3227; E06B 2009/689

(57) ABSTRACT

The invention relates to a device for supporting, advancing and guiding a travelling shaft in a Venetian blind head rail (9) by means of motor or manual operation, wherein the device is used for turning and winding up a slatted Venetian blind and the travelling shaft is rotatably and horizontally displaceably supported in the device in the manner of a travelling shaft bearing housing. The slats are held in cords such as ladder cords or loop cords. The travelling shaft bearing housing (10) has a tubular or circular channel cross-section for the travelling shaft bearing and a projection (12) for guiding a winding cord, through which a winding cord (19) is guided from the centre of the travelling shaft bearing housing to the outer diameter AD of the travelling shaft by means of a convexly curved sliding surface in the slot between the projection with little friction. A cord, a ladder cord loop or a loop cord loop (32) is arranged on the travelling shaft between the winding cord winding (26) and the tubular or circular travelling shaft bearing housing (10). The width B of the projection is narrower than the outer diameter AD of the travelling shaft. A cord, a ladder cord loop or a loop cord loop (32) can pass around the travelling shaft without touching the projection.

### CROSS REFERENCE TO RELATED APPLICATIONS

This nonprovisional application is a national stage entry of PCT Application No. PCT/EP2023/087784, filed Dec. 23, 2023, which in turn claims the benefit of priority under 35 USC § 119 to German Patent Application No. 10 2023 200 053.9, filed on Jan. 1, 2023, the entirety of which are incorporated herein by reference.

### BACKGROUND OF THE INVENTION

### Field of the Invention

The invention relates to a blind drive in a head rail for motor or manual operation, having a turning and winding mechanism for a venetian blind, having a rotatable, tubular, horizontally displaceable travelling wave for winding and unwinding an elevator cord for discharging and pulling up and turning a blind container, which consists of lamellae which are mounted in conductor cords or loop cords.

### Description of the Background

It is known to use a travelling wave in the case of blind drives in order to wind up lift cords of blinds onto the latter and to move up and down a blind curtain by winding up and unwinding and to effect a lamella rotation in the driven hanging by wrapping the travelling wave with a conductor cord loop.

This known travelling wave technique disadvantageously uses a multiplicity of small individual parts made of plastic for mounting and positioning the travelling wave in a Venetian blind head rail, for guiding the lift cords so that they can be wound uniformly onto the travelling wave without overturning, and of guide elements for fixing the position of the conductor cord loops on the travelling wave, and furthermore by fixing pins, in order to anchor the individual parts in a stationary manner into punched out portions of the upper rail.

In order to guide the lift cords and for positionally fixed positioning of the conductor cord loops in order to keep them in position during horizontal displacement of the travelling wave, special clips with openings are required in the prior art, for example. The aim is to save these plastic parts.

A further disadvantage is the production of these many individual parts as injection molding. Plastics are temperature-sensitive and, in the course of the years as a result of high temperatures in the insulating glass, into which the blinds are installed, have outgassing which leads to aging of the plastics, possibly even to “fogging” on the glass panes.

WO 2006/050736 A1 shows a housing with a travelling shaft in which the winding cord is guided to the centre of the travelling shaft, but not with low friction. This can lead to a break in the winding cord. There is also no measure to prevent contact between the ladder cord and housing parts so that the ladder cords do not wear out when the discs are turned. The aim is to prevent any friction between cords and housing parts.

In EP2 589 743 A1, the travelling shaft with the wound-up winding cord slides into a housing. The disadvantage of this design is that the entire travelling shaft movement is arrested when the cords roll over on the travelling shaft. The conductor cords are also not arranged on a travelling shaft. The design lacks information on how the travelling shaft is rotated in order to tilt the slats.

In CH408 694 A1, there is no guide for the winding cord at all. The conductor cords are also not arranged on a travelling shaft, but on a half-cylinder screen above the travelling shaft. This means that there is a lack of integration of many functions in a single component, which is to be guaranteed by the present invention.

### SUMMARY OF THE INVENTION

The aim of the invention is to develop a shutter drive with a multifunctional bearing block, which—also in combination with punchings in the top or top rail—has various functions as
a. mounting of the travelling wave
b. Guidance of the lift cords to the travelling wave
c. Guidance of the Conductor Cord
d. fixing the component in a blind head rail,
   so that the time-consuming puzzle of individual parts can be replaced by a single component which can only be installed in an error-free manner or latched into a head rail. The aim is furthermore to produce the component, for example from aluminum, which ages only insignificantly over the life of a venetian blind.

The object is achieved according to the characterizing part of the main claim.

The innovation is based on the idea of creating a single component for various functions such as the travelling shaft bearing, the guidance of a lift cord on the travelling shaft circumference, the positioning of the ladder cord loops on the travelling shaft and the tight fit of the component in a head rail in order to ensure the assembly and functional reliability of the lift and turning mechanism of a Venetian blind. The integration of many functions in a single component speeds up the assembly process, improves production reliability and ensures error-free installation.

As a result, a complex-shaped component for travelling wave support is obtained, which can be produced by injection molding, but is particularly advantageously also suitable for an extruded aluminum profile. The critical function of the elevator cord guide in order to ensure that the winding does not overlap on the travelling wave is achieved by means of a projection from the tubular travelling wave bearing to the elevator cord guide. The projection can be part of the overall profile or also of plug-in pins which serve for guiding the lift cord.

The aluminum extruded profile 10 for traveling wave bearing has a tubular hollow cross section for receiving a travelling wave 30 including a tubular travelling wave sliding bearing 29 into which the travelling wave 30 is inserted in order to prevent aluminum from rubbing on aluminum. The extruded aluminum profile 10 also has two wing elements 17, 18 which clamp between jaws 20, 21 of the head rails 9 in order to impart a firm fit to the travelling shaft bearing. At the base of the profile there are elongated formations 15, 16 in a base plate 12 with a central slot which snap into a stamped portion 22 of the head rail 9 in order to position the travelling shaft bearing housing 10 exactly in the head rail 9. The central slot in the base plate 12 serves to carry out the lift cords 19. The projection has at least one convexly rounded guide contour in order to guide an elevator cords 19 with low friction from the profile center to the travelling wave circumference AD. The projection is only designed as a twin so that the winding cord can be wound either clockwise or anti-clockwise onto the travelling shaft. One half of a twin would be sufficient.

The width B of the base plate 12 is so narrow that a ladder cord 20, which is inserted into the head rail from below and wraps around the travelling shaft, does not touch the extruded aluminium profile 10. This results in a width B smaller than the outer diameter AD of the travelling shaft 30 (FIG. 4). In the case of a projection of insert pins, these are narrower in their arrangement than the outer diameter OD of the travelling shaft (FIGS. 9, 10). The punching 22 (FIGS. 6, 7) in the base of the head rail 9 is only so wide (b) and long in the region of the conductor cord feedthrough that the conductor cord loop 32 is held stationary and not able to migrate in spite of the migration of the travelling wave 30 on which the conductor cord loop 32 is held stationary.

### BRIEF DESCRIPTION OF THE DRAWINGS

Details and advantages are explained with reference to figures, in which:

FIG. 1 shows a perspective of an extruded profile with a blank as a bearing housing

FIG. 2 shows the side view of the bearing housing

FIG. 3 shows the front view of the bearing housing

FIG. 4 shows a perspective of the bearing housing

FIGS. 5 to 8 show further perspectives of the bearing housing in a blind upper rail

FIGS. 9 to 11 show perspectives of the aluminum extruded profile with plug-in pins

FIG. 12 shows a top view of a head rail with built-in components.

### DETAILED DESCRIPTION OF THE PREFERRED EMBODIMENTS

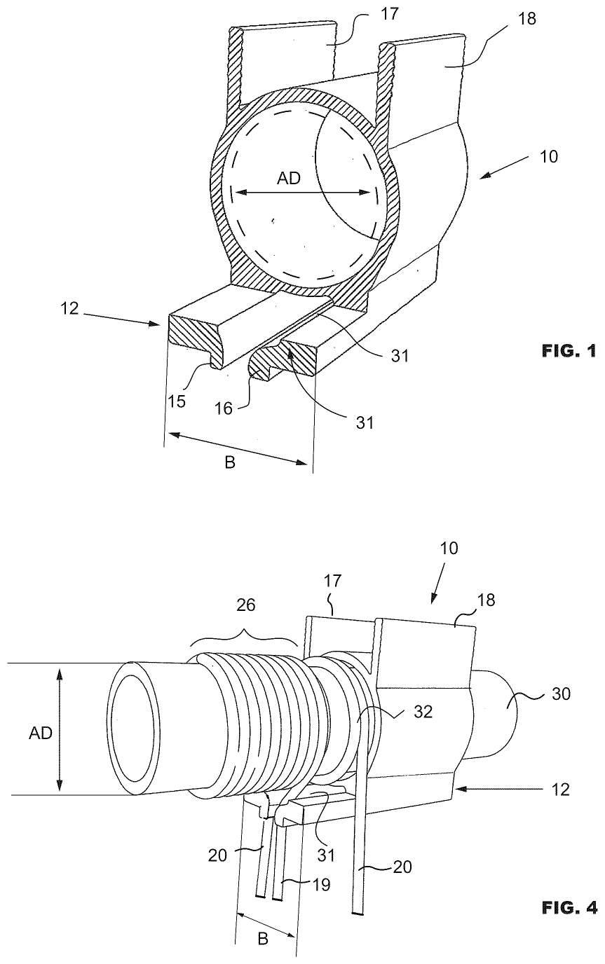

FIG. 1 shows an extruded profile with a blank as a bearing housing part 10 for the travelling wave with free projecting guide elements for the lift cords in the integrated floor plate 12. The base plate 12 is slotted centrally and releases the convex guide contour for the lift cords to the travelling wave circumference. Below the base plate there are rail-shaped press-fit fits 15, 16 for the seat of the profile in a punching out of a head rail. The wing elements 17, 18 serve for locking in a head rail.

FIG. 9 shows the extruded profile with channels 52, 53 for the introduction of steel pins 50, 51, which serve in the slot between the pins of the elevator cord guide.

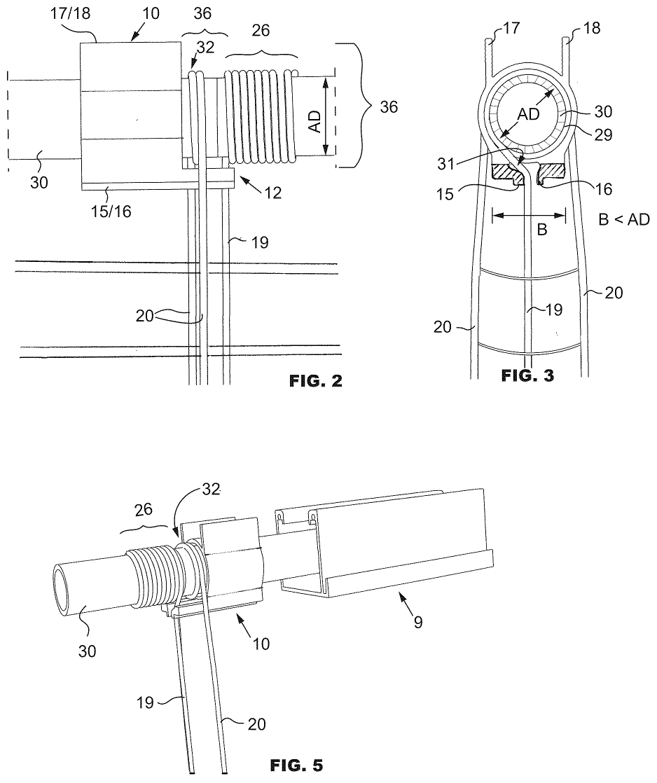

FIG. 2 shows a perspective of the aluminum extrusion profile as a tubular bearing housing 10 for receiving the travelling wave 30. On the basis of this, a bearing housing profile is inserted into the bearing housing profile

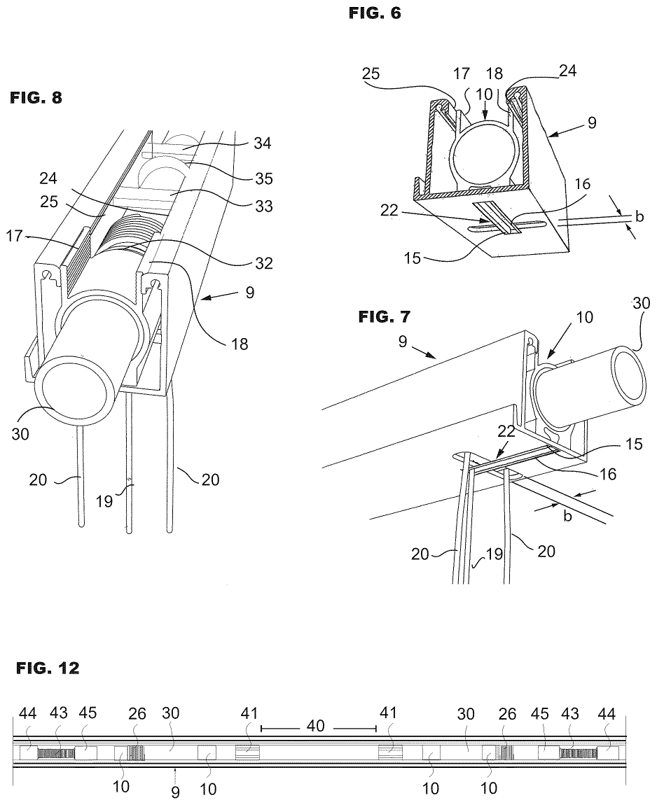

A bottom plate 12 is formed which projects in front of the bearing housing part. This cantilevered bottom plate 12 is made by cutting the profile in the region 20. As can be seen in FIGS. 1 and 3, a central slot through which an elevator cord 19 can be inserted is introduced into this base plate 12. The bottom plate 12—as seen in FIG. 3—has a convex guide contour for the lift cord 19, so that the lift cord is brought up to the travelling wave circumference AD in a low-friction manner and either loops around it or rests only on the travelling wave 30. Rail-shaped press-fit fits 15, 16 are formed below the base plate 12 into the profile which are seated in a punching out of a head rail. The bearing housing 11 has two tabs 17, 18, which, as can be seen in FIGS. 6 and 8, clamp between jaws 24, 25 of a head rail 9, as seen in FIGS. 6 and 8. For a better understanding, FIG.

4 The travelling wave bearing housing 10 with the travelling wave 30, the cord winding 26 and the conductor cord loop 32 is shown as a perspective.

FIG. 5 shows how the bearing housing 10 is inserted into the head rail 9.

FIGS. 6 and 7 show the cross-shaped punch 22 in the base of the head rail 9 into which the rail-shaped press fits 15, 16 of the aluminum extruded profile 10 are fitted. As a result of the cross-shaped punching, conductor cords 20 are introduced into the head rail 9 and the elevator cords 19, as can also be seen in FIG. 7.

FIG. 3 shows a cross-hatching of the section through the base plate 12 into which the guide for the lift cord 19 and the press fit 15, 16 are incorporated. The slot formation in the base plate 12 takes over the function of a guide rail. It takes up the lift cord 19 centrally, the latter sliding friction-free over the convex contour of the guide rail in order to wrap around the travelling wave 30 with the outer diameter AD. The width B of the base plate 12 is preferably narrower than the outer diameter of the travelling wave AD, so that the conductor cord 20 wraps around the travelling wave 30 or can rest thereon without touching the base plate 12. The travelling wave 30 itself is mounted in a tubular slide bearing 29.

The lift cords 19 are subject to considerable friction when the latter experiences a change in direction from the center of the curtain for winding onto the circumference of a travelling wave. This friction represents the weak point of all similar developments, since this leads to wear of the lift cord. The innovative idea is therefore to slide the lift cords as low friction as possible over a convex contour of the guide rail without touching a sharp edge. In order that the lift nozzle 19 does not rub against a cutting edge, the guide contour has a notch 31. The guide contour with the notch 31 is designed at least on one side.

The intelligence of the complex profile contour thus consists in integrating the various functional elements of the travelling wave bearing, the guidance of the lift cords and the conductor cord into the contour of an extruded aluminium housing in such a way that only by a single operation, the separation of a section 20 from the profile 10, the different functional elements are released and all functions are incorporated in only one single component 10 and this can only be used without error in a punching out of a head rail 9.

FIG. 4 shows a perspective of the travelling wave bearing housing 10 with an inserted travelling wave 30, the winding cords 19, 26 wound up and the conductor cord loop 32 or the conductor cord 20. The guide rail 12 protrudes from the bearing housing 10 and guides the lift cords 19 to the travelling wave circumference without touching the cutting edge 32.

FIGS. 7 and 8 show perspective sections through a head rail 9 with the built-in bearing housing 10 and the travelling wave 30. The travelling shaft bearing housing 10 is clamped with the cheeks 17, 18 between jaws 24, 25 of the head rail 9 and imparts a fixed seat in the head rail to the bearing housing. The punch 22 is cross-shaped so that the conductor cord cords 20 and the lift cords 19 can be threaded into the head rail. The bearing housing 10 with the press fit 15, 16 with the central inlet slot for the lift cord 19 is fixed in the head rail 9. The conductor cords 20 slide past the bottom plate and are held in position by the slot width b in the head rail 9 when the travelling wave is displaced.

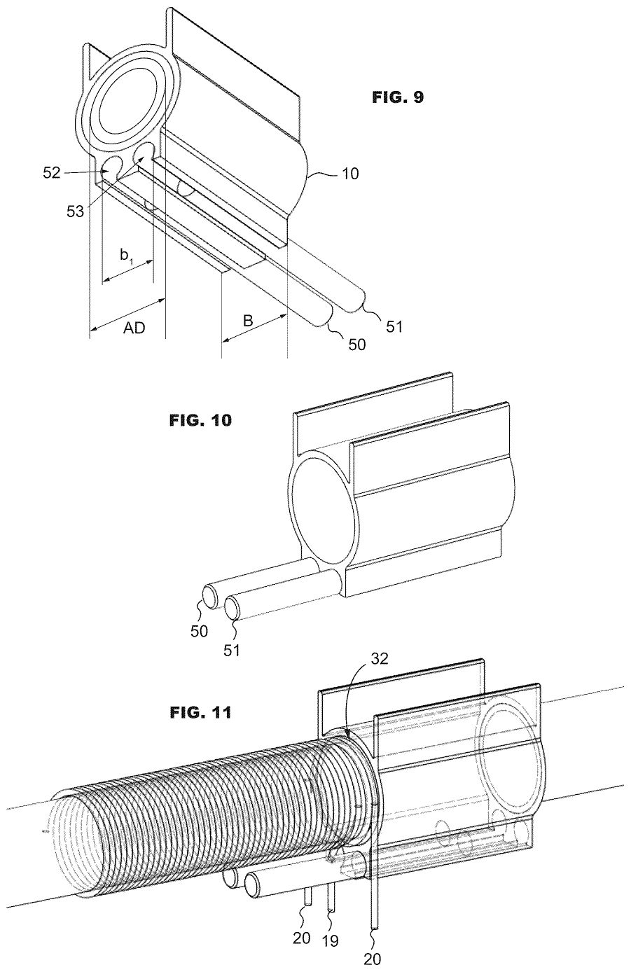

FIGS. 9, 10 and 11 show a bearing block with a projection by means of plug-in pins 50, 51. The bearing block is preferably produced as an extruded profile with channels 52, 53. The plug-in pins 50, 51 are made of steel and have a smooth surface and very low friction to protect the lift cord. FIG. 11 shows the guidance of the conductor cord loop or of the conductor cords and of the centrally fed lift cord.

However, the innovative, multifunctional travelling wave bearing block also requires a novel production of the blind hanging in the conductor cord loop technique. The mounting of the bearing block takes place simultaneously with the introduction of the conductor cord loop, in that the short-circuited end of the conductor cord is introduced into the head rail and is first placed over the guide rail. In FIGS. 2, 4, 5, 8 and 11, a conductor cord loop 32 is shown which wraps around the travelling wave 30. This loop is to be formed before the travelling wave 30 is pushed into the loop 32.

However, this loop 32 is required only with a low shutter weight. The innovation also relates to loops which rest only on the travelling wave without wrapping them. It is only important that the friction be sufficient to turn the lamella when the travelling wave rotates. On the other hand, the freewheel must be ensured when the blinds move up or down.

One advantageous type of manufacture is to connect a special loop 32 at its end to the conductor cord ends 20. The connections between the loop ends and the conductor cord ends are preferably effected by clamps and or by ultrasonic welding. By means of locking clamps on the conductor cords—which are not shown in the figures, the lamella rotation can then be limited to a desired angular dimension by locking or abutting the clamp on the underside of the head rail 9 in such a way that they cannot be drawn into the head rail 9. The lamella rotation is thus blocked and the lamellae are fixed in the desired position.

The cross section of the bearing block 10 is dimensioned such that it fits into a head rail 9 of approximately 25×25 mm. However, the technique is also suitable for larger head rails with dimensions of, for example, 50×50 mm. The outside diameter of the travelling wave 30 is approximately 15 mm for the small head rails, for the large head rails, for example 35 mm, so that hanging up to above 10 m height can be drawn up.

The moving shaft mechanism also includes the stops 33, 34 as switch-off points in FIG. 8 for turning the blinds up and down. In the prior art, shutter drives are used in which the lower and/or upper switch-off points are integrated. This takes place, for example, by means of an encoder which counts the motor revolutions and/or by motor-integrated switches. The object of the present invention is to be able to use simpler motors even without encoders or integrated switches. For this purpose, stop points must be set in order for the blind to remain at the desired point when driving up or down.

The switching off of the travelling wave rotation (FIG. According to the invention, 8) takes place via the stops 33, 34, which stop the horizontal travelling wave movement in the one or the other direction. For this purpose, a stop ring 35 is pushed onto the travelling wave, which stop ring 35 abuts against the stop switches 33, 34 after completion of the travel or on travel and switches off the energization of a motor. According to the blind length, the stop switches are placed within the blind head rail at a defined distance from one another. For a travelling wave with a circumference of U=K×d, the slope is raised by approximately 47.1 mm per revolution at a diameter of 15 mm. In the case of a thickness of the lift cords of 1.5 mm, a feed of the travelling wave of approximately 1.5 mm applies per 47.1 mm, which is realized by means of a screw thread feed. It is thus easy to determine the desired up and down travel of the blind by means of a stop ring 35 over the distance of two detents or stop points 33, 34 which are located opposite one another.

There is also the possibility of being able to run the fixed ring 35 against a freely adjustable stop without a switch if a motor or a controller is installed which switches off the motor under increased resistance.

FIG. 12 shows the components in a head rail. The travelling wave feed is carried out by means of a single-rivet nut 45 in the travelling wave end. A threaded rod 43, which is firmly anchored at the end point 44 in the head rail 9, engages in the rivet nut. Opposite the end of the travelling wave 30 on the motor 40, a form-fitting motor shaft extension 41 engages in a fit which is seated in the travelling wave, so that the travelling wave is carried along in a sliding manner during motor rotation via the motor shaft extension. Upon rotation of the travelling wave, the lift cord is wound up onto the travelling wave next to the travelling shaft bearing block 10 (36).

Instead of a central motor 40 shown in FIG. 12, an end motor or chain drive can be installed in order to set the motor shaft in rotation.

I claim:

1. Roller shutter drive with a travelling shaft (30) and a travelling shaft bearing housing (10) for mounting, advancing and guiding the travelling shaft in a head rail (9) of a louvre blind with slats held in cords such as ladder cords or loop cords;
wherein the travelling shaft (30) is rotatably and horizontally displaceably mounted in the travelling shaft bearing housing and wherein
the discs are held in cords such as ladder cords or loop cords, and wherein
the travelling shaft bearing housing (10) has a tubular or circular channel cross-section for the travelling shaft bearing and
a projection (12) for guiding a winding cord (19) of the louvre blind, wherein the projection has a central slot with a convexly curved sliding surface, through which the winding cord (19) can be guided to the outer diameter (AD) of the travelling shaft with little friction and can wrap around the outer diameter of the travelling shaft or can rest on the travelling shaft, wherein
a cord, a ladder cord loop or a loop cord loop (32) of the louvre blind can be arranged on the travelling shaft between the winding cord winding (26) and the channel cross-section of the travelling shaft bearing housing (10), and wherein
the width B of the projection (12) is equal to or narrower than the outer diameter AD of the travelling shaft, and
wherein a cord, a ladder cord loop or a loop cord loop (32) of the louvre blind for supporting or wrapping around the travelling shaft can slide past the projection without touching it, and
wherein the travelling shaft housing (10) is locked in the head rail (9) by means of a fitting

2. Device according to claim 1, characterized in that the travelling-shaft bearing housing is produced from plastic by injection moulding.

3. Device according to claim 1, characterized in that the travelling wave bearing housing (10) is produced from an extruded aluminium profile and in that the projection takes place by separating a part (36) from the bearing housing (10), so that the projection with the convex guide contour projects in the longitudinal direction of the bearing housing part (10) in order to guide the lift cords.

4. Device according to claim 1, characterized in that the projection on the travelling shaft bearing housing consists of at least one round guide pin (50, 51), wherein the pins are introduced into channels (52, 53) in the travelling shaft bearing housing (10), and in that the round pins (50, 51) of the guide of the lift cord (19) serve from the center of the profile to the outer diameter AD of the travelling wave (30).

5. Device according to claim 1, characterized in that a plastic sliding bearing (29) for receiving the travelling wave (30) is installed in the tubular cross-section of the travelling wave bearing housing (10).

6. Device according to claim 1, characterized in that the travelling wave bearing housing (10) is fitted in a cross-shaped or T-shaped punching (22) fitted in the head rail (9), wherein the punching out transversely to the longitudinal direction of the head rail in the slot width b is so narrow that a conductor cord loop or loop cord loop (32) is held stationary on the travelling wave (30) when the travelling wave is displaced.

7. Device according to claim 1, characterized in that the feed of the travelling wave (12) takes place by means of a screw thread (43) in a nut thread (45), which sits on a travelling shaft end, and in that the rotation of the travelling wave (12) takes place by means of a sliding bearing fit at the opposite travelling shaft end, wherein an extension of a motor drive shaft engages in the sliding bearing fit (42), so that the travelling wave experiences a rotational movement during motor rotation and at the same time a feed and, as a result, the lift cord (19) can be wound spirally.

8. Device according to claim 7, characterized in that the screw thread pitch is select-ed in such a way that a feed in the thickness of the lift cord takes place during a complete revolution.

9. Device according to claim 1, characterized in that the travelling wave (30) is fitted with a locking ring (35) for fixing the switch-off point of the upward and downward travel of the blind, in which the locking ring runs against a stop (32, 33), wherein the stop serves as a signal transmitter for energizing and switching off a motor, and wherein by positioning the stops (32, 33) along the head rail the stop points for the up and down travel of a blind are set.
